(19) United States
(12) Patent Application Publication
(10) Pub. No.: US 2020/0353461 A1
(43) Pub. Date: Nov. 12, 2020

(54) HOLDER AND FLUID HANDLING DEVICE

(71) Applicant: Enplas Corporation, Saitama (JP)

(72) Inventor: Shigeru UEMURA, Saitama (JP)

(73) Assignee: Enplas Corporation, Saitama (JP)

(21) Appl. No.: 16/966,020

(22) PCT Filed: Jan. 30, 2019
(86) PCT No.: PCT/JP2019/003079

§ 371 Date: Jul. 30, 2020

(30) Foreign Application Priority Data
Jan. 31, 2018 (JP) 2018-014838

(51) Int. Cl. B01L 3/00; G01N 35/10; B01L 7/00

(52) U.S. Cl. CPC B01L 3/5025; B01L 2400/0487; B01L 7/00; G01N 35/1095

(57) ABSTRACT

To provide a holder in which a liquid is not prone to remain in a communicating hole when the liquid is manipulated using a syringe. The holder has a side wall, a plurality of chambers, and one or more communicating hole groups including a plurality of communicating holes. The communicating directions of the plurality of communicating holes included in a single communicating hole group are parallel to each other. The plurality of communicating holes each have essentially the same shape as viewed from the direction of a line normal to an outside opening thereof.

### TECHNICAL FIELD

The present invention relates to a housing portion and a fluid handling device including the housing portion.

### BACKGROUND ART

In general, biological materials such as blood, proteins, and DNA are analyzed by mixing the material with reagents or by performing steps such as heating, cooling, and detection. Recently, a device for continuously performing such a plurality of steps are known (see, for example, patent literature (hereinafter also referred to as PTL) 1).

PTL 1 discloses a multi-chamber type rotary valve (fluid handling device) including an insert (housing portion) and a cartridge body (case) for rotatably housing the insert. The insert includes a plurality of chambers formed therein. In the side walls of the insert, a plurality of through holes respectively corresponding to the chambers are formed. In the side wall of the cartridge body, an insertion slot where a syringe can be inserted is formed at a height corresponding to that of the through holes. Each chamber is previously filled with a liquid such as a reagent or a sample necessary for analysis.

In the multi-chamber type rotary valve disclosed in PTL 1, for example, a syringe is inserted into a first through hole corresponding to a first chamber from the insertion slot and a sample filling the first chamber is sucked into the syringe. The insert is then rotated in the circumferential direction in such a manner that the second through hole corresponding to the second chamber is aligned with the insertion slot, and the reagent filling the second chamber is sucked into the syringe, thereby mixing the sample and the reagent in the syringe. In addition, to heat the mixed liquid of the sample and the reagent, the mixed liquid in the syringe is discharged into a third chamber for heating, and the multi-chamber type rotary valve is heated by using a heating device or the like, thereby heating the mixed liquid.

### CITATION LIST

### Patent Literature

### PTL 1

### Japanese Unexamined Patent Application Publication (Translation of PCT Application) No. 2012-522996

### SUMMARY OF INVENTION

### Technical Problem

The multi-chamber type rotary valve disclosed in PTL 1 should be replaced for each analysis, and therefore, the valves are often manufactured inexpensively by injection molding using a resin material. When manufacturing an insert including a plurality of through holes by injection molding, in order to simplifying the manufacturing step and reducing the manufacturing cost, the through holes may be formed by using mold pins having the same (for example, columnar) shape that are slidable in the same direction. Thus in the insert formed with through holes therein by using the mold pins slidable in the same direction, the outer opening of the central through hole formed along the normal of the outer peripheral surface of the insert is formed in a desired shape (for example, circular shape). On the other hand, the outer openings of the other through holes formed obliquely with respect to the normal of the outer peripheral surface of the insert are formed in a shape that extends in the circumferential direction (for example, elliptical shape).

At the central through hole in which the opening is appropriately formed, the shape of the syringe matches the shape of the outer opening, and thus liquid is less likely to remain in the insert. On the other hand, at the other through holes, the shape of the syringe does not match the shape of the outer opening, and thus liquid is more likely to remain in the gap between the syringe and the outer opening. Liquid that remains in this manner may be transferred to the space between the insert and the cartridge when the insert is rotated, and thus mixed with another liquid or the like.

An object of the present invention is to provide a housing portion in which a liquid is less likely to remain in a communication hole when the liquid is manipulated by using a syringe, and a fluid handling device including the housing portion.

### Solution to Problem

A housing portion of the present invention is a housing portion for manipulating a fluid by using a syringe, the housing portion being rotatably housed in a case about a rotation axis, the housing portion including: a side wall formed in a substantially cylindrical shape; chambers formed inside the side wall; and one or more communication hole groups each including linearly extending communication holes which are formed at the side wall at the same height in an axial direction of the rotation axis, each one of the communication holes allowing one of the chambers to communicate with an outside of the side wall, in which communication directions of the communication holes included in one of the communication hole groups are parallel to each other, and outer openings of the communication holes viewed from a normal direction have substantially the same shape.

A fluid handling device of the present invention includes: the housing portion according to the present invention and a case for housing the housing portion, in which the case includes a case body for rotatably holding the housing portion, and an insertion portion for inserting a syringe to the outer openings of the communication holes, the insertion portion being at a side wall of the case body and formed at a height corresponding to the outer openings of the communication holes.

### Advantageous Effects of Invention

In the housing portion of the present invention, liquid is less likely to remain in a communication hole when the liquid is manipulated by using a syringe.

### BRIEF DESCRIPTION OF DRAWINGS

FIGS. 1A to 1C illustrate a configuration of a fluid handling device;

FIGS. 2A and 2B illustrate a configuration of a housing portion;

FIGS. 3A to 3C illustrate a configuration of a case;

FIGS. 4A and 4B are diagrams for explaining communication holes of the housing portion according to the present embodiment;

FIGS. 5A and 5B are diagrams for explaining the remaining of a liquid;

FIGS. 6A and 6B are diagrams for explaining communication holes of a housing portion of a comparative example; and

FIGS. 7A and 7B are diagrams for explaining the remaining of a liquid.

### DESCRIPTION OF EMBODIMENTS

Hereinafter, a housing portion and a fluid handling device including the housing portion according to the present embodiment are described with reference to the accompanying drawings.

(Configuration of Fluid Handling Device)

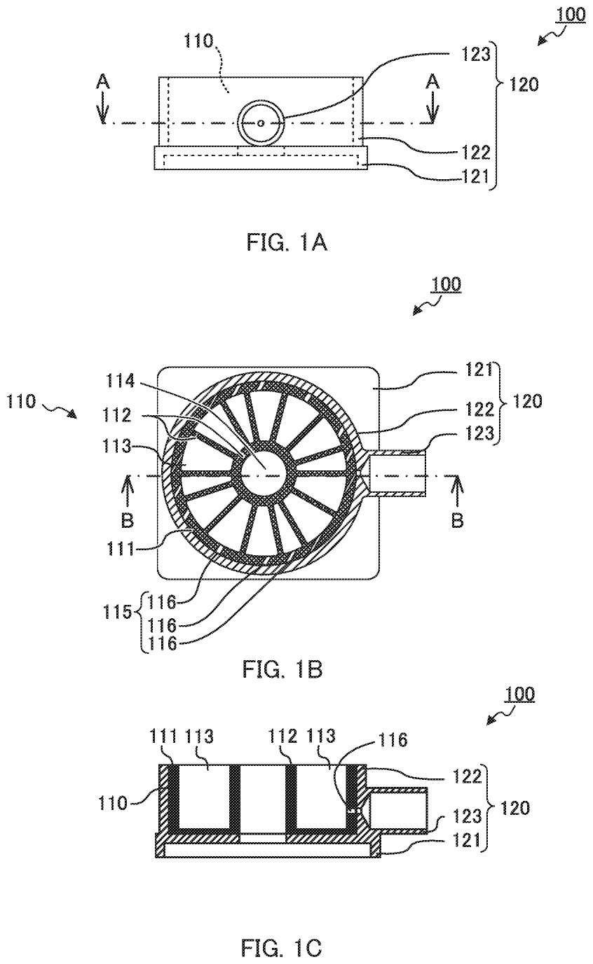

FIGS. 1A to 1C illustrate a configuration of fluid handling device 100. FIG. 1A is a side view of fluid handling device 100, FIG. 1B is a cross-sectional view taken along line A-A shown in FIG. 1A, and FIG. 1C is a cross-sectional view taken along line B-B shown in FIG. 1B.

As illustrated in FIGS. 1A to 1C, fluid handling device 100 includes housing portion 110 and case 120. Fluid handling device 100 is used with housing portion 110 housed in case 120. Fluid handling device 100 is used, for example, for analyzing a substance to be detected in a sample by manipulating a liquid or a gas such as a reagent or a sample with the use of a syringe while intermittently rotating housing portion 110 with respect to case 120.

Housing portion 110 and case 120 are formed as separate bodies, and assembled into fluid handling device 100. The method for manufacturing housing portion 110 and case 120 is not particularly limited. Housing portion 110 and case 120 are preferably manufactured by injection molding using a resin material from the viewpoint of manufacturing cost. The materials of housing portion 110 and case 120 are not particularly limited as long as they are resistant to the reagents used for analysis and do not deform at the temperature during analysis. Examples of the material of housing portion 110 and case 120 include polypropylene (PP), thermoplastic polyurethane elastomer (TPU) and polycarbonate (PC).

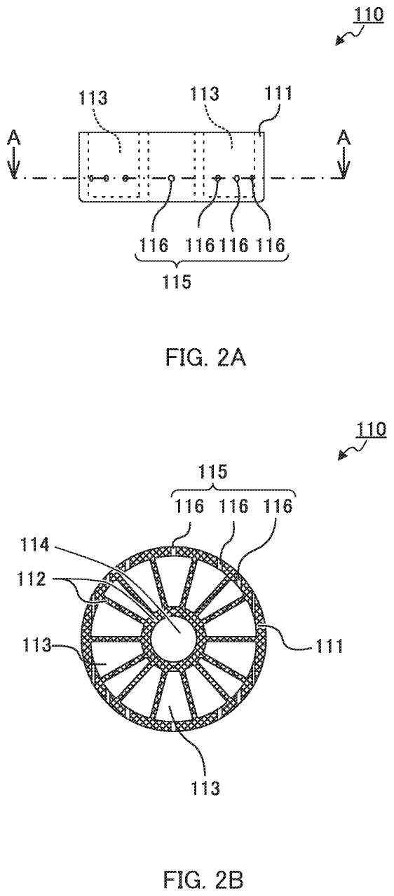

FIGS. 2A and 2B illustrate a configuration of housing portion 110. FIG. 2A is a side view of housing portion 110, and FIG. 2B is a cross-sectional view taken along line A-A shown in FIG. 2A.

Housing portion 110 is housed so as to be rotatable about the rotation axis with respect to case 120. Housing portion 110 has a substantially cylindrical shape with its bottom closed. In a direction perpendicular to the rotation axis, the outer shape of housing portion 110 is a circle. Housing portion 110 includes side wall 111, a plurality of chambers 113, and one or more communication hole groups 115. Side wall 111 defines the outer shape of housing portion 110. In addition, in housing portion 110, inner wall 112 separates chambers 113 from each other, and also separates a columnar inner hole 114 from other chambers.

Chamber 113 temporarily stores a liquid or a gas (hereinafter, simply referred to as “fluid”) such as a sample or a reagent, and also functions as a reaction tank for the reaction of the fluid or the like. The number of chambers 113 is not particularly limited. The number of chambers 113 can be appropriately set according to the step required for analysis. The number of chambers 113 is 14 in the present embodiment. The size of each chamber 113 is not particularly limited either. Chambers 113 may have the same size or different sizes. In the present embodiment, chamber 113 in the upper half of the drawing in FIG. 2B has the same shape as chamber 113 that correspond to the chamber 113 of the upper half of the drawing in the lower half of the drawing. That is, in the present embodiment, the plurality of chambers 113 are formed so as to be symmetric with respect to a cross section including the rotation axis as the boundary.

One or more communication hole groups 115 each including a plurality of communication holes 116 are formed at (in) side wall 111. In the present embodiment, two communication hole groups 115 are formed at side wall 111. The number of communication holes 116 is 14 which is the same as the number of chambers 113. In addition, one communication hole group 115 includes seven communication holes 116. Since the shape of communication hole 116 is the main feature in the present embodiment, their details will be described below.

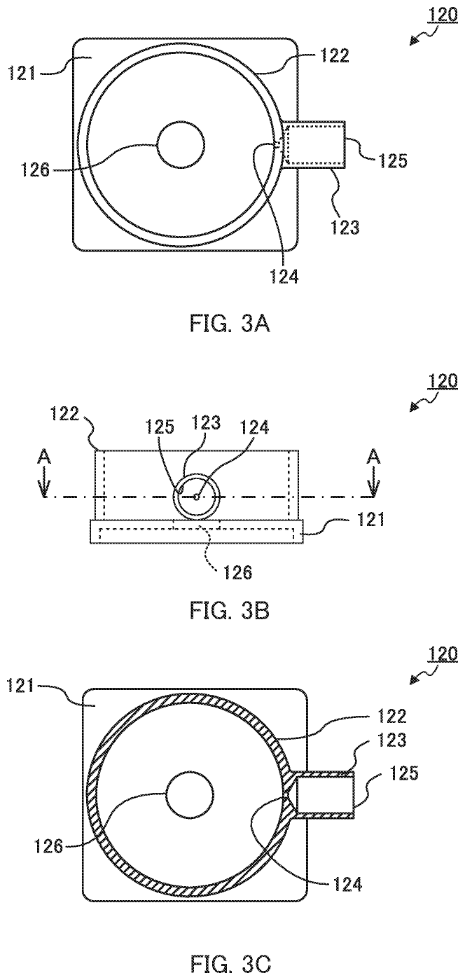

FIGS. 3A to 3C illustrate a configuration of case 120. FIG. 3A is a plan view of case 120, FIG. 3B is a side view of case 120, and FIG. 3C is a cross-sectional view taken along line A-A shown in FIG. 3B.

Case 120 rotatably houses housing portion 110 about the rotation axis. Case 120 includes base 121, case body 122 and insertion portion 123.

Base 121 which is used for the installation of case body 122 also functions as an installation portion for an external device such as a heating and cooling device. Case body 122 is fixed at the upper portion of base 121. At the center portion of base 121, hole 126 opened on the front and rear surfaces of base 121 is formed.

Case body 122 rotatably houses housing portion 110 about the rotation axis. Case body 122 is formed in a cylindrical shape. The inner peripheral surface of case body 122 is slightly larger than the outer peripheral surface of housing portion 110. At the side wall 111 of case body 122, insertion portion 123 for inserting a syringe is disposed.

Insertion portion 123 is formed in a tubular shape. The shape of the inner surface of insertion portion 123 is preferably substantially complementary to the syringe. Insertion portion 123 is configured such that the tip of the syringe can be inserted into inner opening 124 of insertion portion 123. In other words, the shape of inner opening 124 of insertion portion 123 is complementary to the tip of the syringe, and the shape of outer opening 125 of insertion portion 123 is complementary to the outer shape of the syringe. The height of inner opening 124 of insertion portion 123 with respect to case body 122 is the same as that of communication hole 116 when housing portion 110 is housed in case 120.

Although not illustrated, housing portion 110 may include a lid for closing at least a part of the opening of each chamber 113.

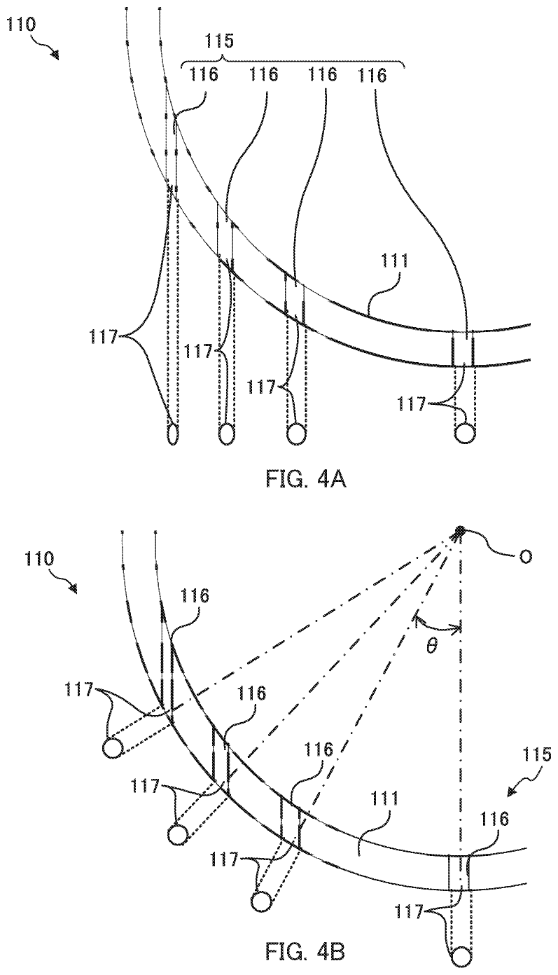

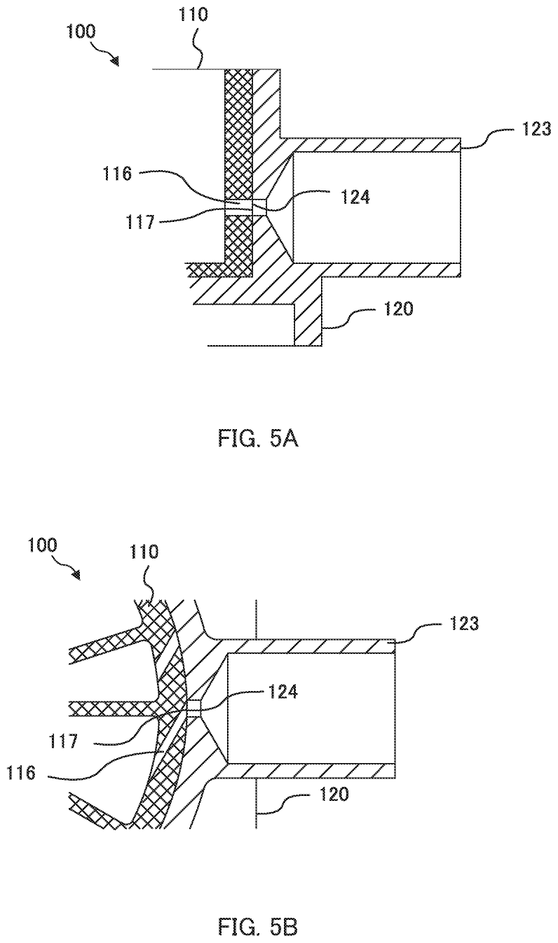

Here, communication hole group 115 formed in housing portion 110 will be described in detail. For comparison, communication hole group 115a in housing portion 110a of the comparative example will also be described. FIGS. 4A and 4B are partially enlarged cross-sectional views of housing portion 110 for explaining communication hole group 115. FIG. 4A is a partially enlarged cross-sectional view of housing portion 110 for explaining the shape of communication hole 116 when communication hole group 115 of housing portion 110 according to the present embodiment is viewed from the axial direction of communication hole 116, and FIG. 4B is a partially enlarged cross-sectional view of housing portion 110 for explaining the shape of communication hole 116 when communication hole group 115 of housing portion 110 according to the present embodiment is viewed from the normal direction of the outer peripheral surface of side wall 111 of housing portion 110. FIGS. 5A and 5B are diagrams for explaining the remaining of a liquid. FIG. 5A is a partially enlarged cross-sectional view when fluid handling device 100 is viewed from the side, FIG. 5B is a partially enlarged cross-sectional view when fluid handling device 100 is viewed from above. In FIGS. 4A and 4B, the inner structure of housing portion 110 and hatching of side wall 111 are omitted.

As described above, housing portion 110 according to the present embodiment includes two communication hole groups 115. Corresponding communication directions of the plurality of communication holes 116 included in the two communication hole groups 115 are parallel to each other. That is, the two communication hole groups 115 are formed so as to be symmetric with respect to a cross section including the rotation axis, as the boundary. Communication holes 116 extend linearly toward chamber 113 from the outside of side wall 111 that allows communication. The number of communication holes 116 in communication hole group 115 is the same as the number of chambers 113. In the present embodiment, the number of communication holes 116 in communication hole group 115 is seven.

The shape of outer opening 117 of communication hole 116 is not particularly limited. Outer opening 117 of communication hole 116 preferably has a shape complementary to the shape of the tip of a syringe to be used. Examples of the shape of outer opening 117 of communication hole 116 include circles, ellipses, and rectangles. In the present embodiment, the shape of outer opening 117 of communication hole 116 is a circle.

As illustrated in FIG. 4A, the shapes of outer openings 117 of communication holes 116 when viewed along the axial direction of communication hole 116 are not the same. More specifically, the shape of outer opening 117 of the central communication hole 116 where the axis of communication hole 116 coincides with the normal of side wall 111 of housing portion 110 is a circle. However, outer opening 117 of communication hole 116 shifted from the central communication hole 116 in the circumferential direction has an elliptical shape that is longer in the height direction. Further, the longer the distance of communication hole 116 from the central communication hole 116 becomes, the shorter the width of outer opening 117 (the length of the short axis) becomes.

On the other hand, as illustrated in FIG. 4B, the shapes of outer openings 117 of communication holes 116 in the normal direction of the outer peripheral surface of side wall 111 of housing portion 110 have substantially the same shape. Here, “substantially the same” is not meant to indicate only perfectly the same shape, but is meant to include manufacturing errors.

In fluid handling device 100 according to the present embodiment, outer opening 117 of communication hole 116 in the normal direction of the outer peripheral surface of side wall 111 preferably has a shape substantially the same as the shape of inner opening 124 of insertion portion 123, so that a fluid does not remain in outer opening 117 of communication hole 116 when the liquid is put into or taken out of (manipulated) chamber 113 by using a syringe. More specifically, the difference is preferably 5% or less between the area of outer opening 117 of communication hole 116 in the normal direction of the outer peripheral surface of side wall 111 and the area of inner opening 124 of insertion portion 123 (see FIG. 3). Thus, it is possible to minimize the gap between outer opening 117 of communication hole 116 in the normal direction of the outer peripheral surface of side wall 111 and inner opening 124 of insertion portion 123.

In one communication hole group 115, adjacent two communication holes 116 are disposed apart from each other by, for example, 0 of 15° or more, with rotation axis O as a reference.

In order to form such communication hole group 115 (communication holes 116) by injection molding, a mold pin group (mold pins) corresponding to the shape of each communication hole group 115 (communication holes 116) is required. In the present embodiment, the number of the mold pin groups for forming communication hole groups 115 is two. Specifically, with a cross section including the rotation axis of housing portion 110 as a boundary, a mold pin group for forming a half of communication hole groups 115 and a mold pin group for forming the other half of communication hole groups 115 are required. In addition, a mold pin has a shape corresponding to one of communication holes 116. That is, in the present embodiment, the mold pin located in the center of the mold pin group has a columnar shape. On the other hand, mold pins located on the side of the mold pin group have an elliptical cylindrical shape such that the longer the distance of a mold pin from the central mold pin becomes, the shorter the length of the mold pin in the arrangement direction of the mold pins becomes, and the longer the length of the mold pin in a direction perpendicular to the arrangement direction becomes.

Here, a description will be given whether or not a liquid remains when a liquid is used as the fluid. As illustrated in FIG. 5A, in fluid handling device 100 according to the present embodiment, when fluid handling device 100 is viewed from the side, the height of outer opening 117 of communication hole 116 is the same as the height of inner opening 124 of insertion portion 123, and therefore, no liquid remains in the vertical direction of outer opening 117 of communication hole 116. In addition, as illustrated in FIG. 5B, when fluid handling device 100 is viewed from above, the width of outer opening 117 of communication hole 116 and the width of inner opening 124 of insertion portion 123 are the same, and therefore, no liquid remains at both ends of outer opening 117 of communication hole 116 in the width direction. Therefore, when housing portion 110 is intermittently rotated, no liquid flows into the space between housing portion 110 and case 120. When the liquid is manipulated in the next step, the liquid does not mix into another liquid.

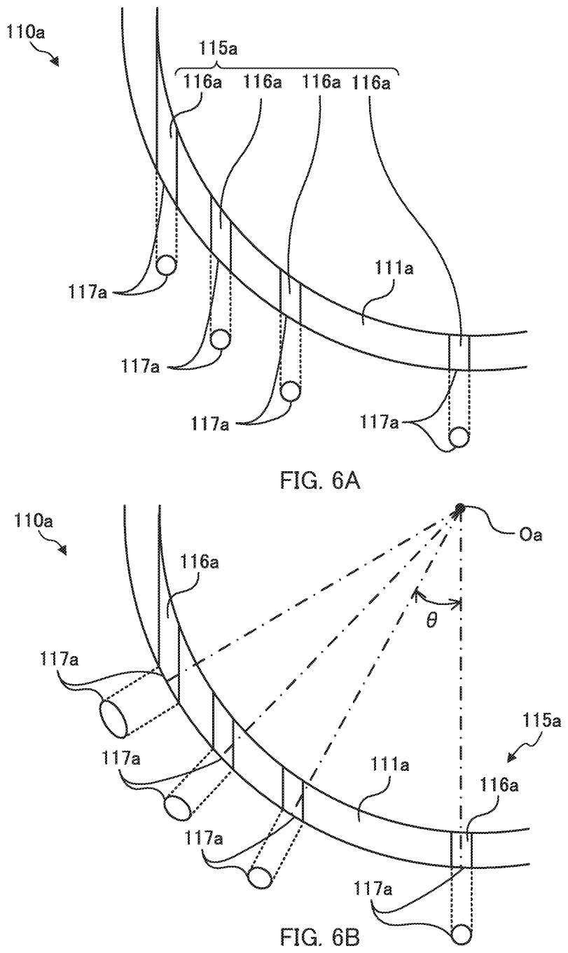

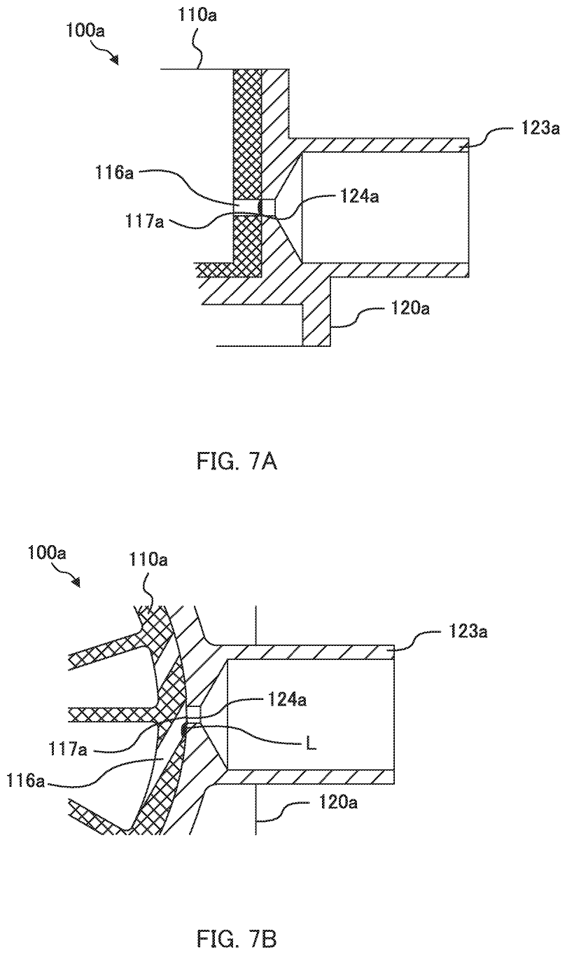

FIGS. 6A and 6B are a partially enlarged cross-sectional views of housing portion 110a for explaining communication hole group 115a of a comparative example. FIG. 6A is a partially enlarged cross-sectional view of housing portion 110a for explaining the shape of communication hole 116a when communication hole group 115a of housing portion 110a of the comparative example is viewed from the axial direction of communication hole 116a, and FIG. 6B is a partially enlarged cross-sectional view of housing portion 110a for explaining the shape of communication hole 116a when communication hole group 115a of housing portion 110a of the comparative example is viewed from the normal direction of the outer peripheral surface of side wall 111a of housing portion 110a. FIGS. 7A and 7B are diagrams for explaining the remaining of a liquid. FIG. 7A is a partially enlarged cross-sectional view when fluid handling device 100a is viewed from the side, FIG. 7B is a partially enlarged cross-sectional view when fluid handling device 100a is viewed from above. In FIGS. 6A and 6B, the inner structure of the housing portion and hatching of side wall 111a are omitted.

As illustrated in FIGS. 6A and 6B, in fluid handling device 100a of the comparative example, all of outer openings 117a of communication holes 116a have a circular shape when viewed along the axial direction of communication hole 116a. In addition, in the cross section perpendicular to the rotation axis of housing portion 110a, except for the case where the axis of communication hole 116a coincides with the normal of side wall 111a of housing portion 110a, outer opening 117a of communication hole 116a in the normal direction has an elliptical shape that is longer in its width direction.

Similarly, a description will be given whether or not a liquid remains when a liquid is used as the fluid. As illustrated in FIG. 7A, in fluid handling device 100a of the comparative example, when fluid handling device 100a is viewed from the side, the height of outer opening 117a of communication hole 116a is the same as the height of inner opening 124a of insertion portion 123a, and therefore, no liquid remains in the vertical direction of outer opening 117a of communication hole 116a. However, as illustrated in in FIG. 7B, when fluid handling device 100a is viewed from above, the width of outer opening 117a of communication hole 116a is longer than the width of inner opening 124a of insertion portion 123a, and therefore, liquid L remains at both ends of outer opening 117a of communication hole 116a in the width direction. Therefore, when housing portion 110a is intermittently rotated, liquid flows into the space between housing portion 110a and case 120a. When the liquid is manipulated in the next step, the remaining liquid mixes into a new liquid.

(Effects)

As described above, in the present invention, all of outer openings 117 of communication holes 116 in the normal direction of the outer peripheral surface of side wall 111 of housing portion 110 have substantially the same shape, and thus a liquid is less likely to remain in housing portion 110. Accordingly, since liquid can be manipulated accurately, it is possible to increase the detection accuracy. Further, the fluid handling device according to the present embodiment is applicable to analysis of not only a liquid but also a gas and the like.

This application claims priority based on Japanese Patent Application No. 2018-014838 filed on Jan. 31, 2018, the entire contents of which including the specification and the drawings are incorporated herein by reference.

### INDUSTRIAL APPLICABILITY

The housing portion and fluid handling device of the present invention can be applied to, for example, analysis of a trace amount of a biological sample or the like.

### REFERENCE SIGNS LIST

100, 100a Fluid handling device
110, 110a Housing portion
111 Side wall
112 Inner wall
113 Chamber
114 Inner hole
115, 115a Communication hole group
116, 116a Communication hole
117, 117a Outer opening of communication hole
120, 120a Case
121 Base
122 Case body
123, 123a Insertion portion
124, 124a Inner opening of insertion portion
125 Outer opening of insertion portion
126 Hole

1. A housing portion for manipulating a fluid by using a syringe, the housing portion being rotatably housed in a case about a rotation axis, the housing portion comprising:
a side wall formed in a substantially cylindrical shape;
chambers formed inside the side wall; and
one or more communication hole groups each including linearly extending communication holes which are formed at the side wall at a same height in an axial direction of the rotation axis, each one of the communication holes allowing one of the chambers to communicate with an outside of the side wall,
wherein
communication directions of the communication holes included in one of the communication hole groups are parallel to each other, and
outer openings of the communication holes viewed from a normal direction have substantially a same shape.

2. The housing portion according to claim 1, wherein, in the one of the communication hole groups, adjacent two of the communication holes are disposed apart from each other by 15° or more with the rotation axis as a reference.

3. The housing portion according to claim 1, comprising:
two of the communication hole groups, wherein
the communication holes included in the two of the communication hole groups are formed at a same height in the axial direction.

4. The housing portion according to claim 3, wherein:
communication directions of the communication holes included in the two of the communication hole groups are parallel to each other.

5. A fluid handling device, comprising:
the housing portion according to claim 1; and
a case for housing the housing portion,
wherein the case includes
a case body for rotatably holding the housing portion, and
an insertion portion for inserting a syringe to the outer openings of the communication holes, the insertion portion being at a side wall of the case body and formed at a height corresponding to the outer openings of the communication holes.

6. The fluid handling device according to claim 5, wherein a difference between an area of any one the outer openings of the communication holes and an area of an inner opening of the insertion portion is 5% or less.

7. The housing portion according to claim 2, comprising:
two of the communication hole groups, wherein
the communication holes included in the two of the communication hole groups are formed at a same height in the axial direction.

8. A fluid handling device, comprising:
the housing portion according to claim 2; and
a case for housing the housing portion,
wherein the case includes
a case body for rotatably holding the housing portion, and
an insertion portion for inserting a syringe to the outer openings of the communication holes, the insertion portion being at a side wall of the case body and formed at a height corresponding to the outer openings of the communication holes.

9. A fluid handling device, comprising:
the housing portion according to claim 3; and
a case for housing the housing portion,
wherein the case includes
a case body for rotatably holding the housing portion, and
an insertion portion for inserting a syringe to the outer openings of the communication holes, the insertion portion being at a side wall of the case body and formed at a height corresponding to the outer openings of the communication holes.

10. A fluid handling device, comprising:
the housing portion according to claim 4; and
a case for housing the housing portion,
wherein the case includes
a case body for rotatably holding the housing portion, and
an insertion portion for inserting a syringe to the outer openings of the communication holes, the insertion portion being at a side wall of the case body and formed at a height corresponding to the outer openings of the communication holes.

11. A fluid handling device, comprising:
the housing portion according to claim 7; and
a case for housing the housing portion,
wherein the case includes
a case body for rotatably holding the housing portion, and
an insertion portion for inserting a syringe to the outer openings of the communication holes, the insertion portion being at a side wall of the case body and formed at a height corresponding to the outer openings of the communication holes.
